(19) United States
(12) Patent Application Publication
(10) Pub. No.: US 2008/0219497 A1
(43) Pub. Date: Sep. 11, 2008

(54) IMAGE PROCESSING DEVICE, RECORDING MEDIUM, AND IMAGE PROCESSING METHOD

(75) Inventor: Ariyoshi Hikosaka, Nara (JP)

Correspondence Address: GLOBAL IP COUNSELORS, LLP, 1233 20TH STREET, NW, SUITE 700, WASHINGTON, DC, 20036-2680, US

(73) Assignee: c/o Kyocera Mita Corporation, Osaka (JP)

(21) Appl. No.: 12/034,417

(22) Filed: Feb. 20, 2008

(30) Foreign Application Priority Data
Mar. 7, 2007 (JP) 2007-056833

(51) Int. Cl. G06K 9/00

(52) U.S. Cl. 382/100

(57) ABSTRACT

An image processing device for embedding digital watermarking data into image data of a manuscript includes a storage device that stores digital watermarking data, a margin area detecting device that detects a margin area that is different from an object on which printing is performed, a margin size calculating device that calculates the size of the margin area, a data amount calculating device that calculates the data amount of the digital watermarking data that is allowed to be embedded within the size of the margin area, an extracting device that extracts digital watermarking data from a plurality of sets of digital watermarking data stored in the storage device according to the extraction priority order based on the data amount calculated by the data amount calculating device, and an embedding device that embeds the digital watermarking extracted by the extracting device into the margin area.

### CROSS-REFERENCE TO RELATED APPLICATIONS

This application claims priority to Japanese Patent Application No. 2007-056833, the entirety of which is hereby incorporated by reference.

### BACKGROUND OF THE INVENTION

2. Field of the Invention

The present invention relates to an image processing device, a recording medium, and an image processing method. More particularly, the present invention relates to an image processing device, a recording medium, and an image processing method, all of which are configured to embed digital watermarking data into image data of a manuscript.

In the printing device, the digital watermarking is used for preventing illegal duplication of a sheet of paper on which image data are printed and the image data itself. It is also used for specifying the source from which the paper and the image data are leaked. For example, it is possible to track back the leakage route by embedding information of a source from which the image data were outputted into the image data as the digital watermarking. The digital watermarking is also used for checking if data falsification is conducted or not and for checking if the data are genuine or not.

Japan Patent Application Publication No. JP-A-2005-38243 discloses an example of the digital watermarking used as described above, that is, a technique for detecting a blank portion that does not include any character data and then embedding the digital watermarking into the blank portion.

According to the above described technique, it is possible to embed the digital watermarking data into a manuscript if there is a blank space of a predetermined size. However, a manuscript does not necessarily have enough blank space. In this case, a user produces a blank space by reducing the scale of the image data. Then, the digital watermarking is embedded into the produced blank space. Thus, this sort of complicated procedure has been performed.

In view of the above, it will be apparent to those skilled in the art from this disclosure that there exists a need for an improved image processing device, recording medium, and image processing method. This invention addresses this need in the art as well as other needs, which will become apparent to those skilled in the art from this disclosure.

### SUMMARY OF THE INVENTION

An object of the present invention is to provide an image processing device and the like, which are configured to be capable of easily embedding the digital watermarking into a blank space on a manuscript even when the blank space is small.

For the purpose of achieving the above described object, an image processing device produced by the present invention is based on the premise that it is capable of performing embedding of the digital watermarking data.

First, this type of image processing device is provided with a storage device to associate and to store a plurality of digital watermarking data, extraction priority order being configured to be given to each of the plurality of digital watermarking data. A media access control (MAC) address, a host name, a printing date and time, an IP address, a document name, a user defined information, and the like are allowed to be used as the plurality of sets of digital watermarking data. A user is capable of giving an extraction priority order to each of digital watermarking data. In addition, a user is capable of setting the maximum data amount of each set of the digital watermarking data, which is allowed to be embedded into the image data of a manuscript. The data amount depends on the number of and the kind of the digital watermarking data to be embedded.

Furthermore, the image processing device includes a margin area detecting device to detect a margin area that is configured not to be an object for which printing is performed within a printable area that is configured to be an area that the image data of the manuscript is allowed to be printed therein, a margin size calculating device to calculate the size of the margin area detected by the margin area detecting device, and a data amount calculating device to calculate the data amount of the digital watermarking data that is allowed to be embedded within the size of the margin area that is calculated by the margin size calculating device.

Note that the margin area that is configured not to be an object for which printing is performed preferably means an area on a sheet of paper in which a character, a diagram, or the like is not printed when printing image data are outputted on the sheet of paper. The margin area detecting device detects whether a margin area exists in the image data of a manuscript. Specifically, the printing image data are expanded to a visually recognizable image data (e.g., bitmap data), and whether a margin area exists in the image data or not is detected. When the margin area is detected by the margin area detecting device, the size of the detected margin area is calculated by the margin size calculating device. Specifically, the size is calculated by referring to the image data produced by expanding the printing image data, as is the case with the above. When the size of the margin area is calculated, the data amount of the digital watermarking data that is allowed to be embedded into the margin area is calculated.

Furthermore, the image processing device includes an extracting device to extract digital watermarking data from a plurality of digital watermarking data stored in the storage device according to the extraction priority order based on the data amount calculated by the data amount calculating device, and an embedding device to embed the digital watermarking data extracted by the extracting device into the margin area detected by the margin area detecting device. Accordingly, it is possible to embed the digital watermarking data so as to fit in the size of the margin area. In addition, the extracting device extracts digital watermarking data according to the extraction priority order that is set by a user. Therefore, it is possible to embed sequentially the digital watermarking data in a descending order of importance of a user.

As described above, even when the printable area includes only a small margin area, it is possible to embed the digital watermarking so as to fit in the size of the margin area. As a result, the present invention does not require a conventionally performed complicated operation that a user produces a margin area by reducing the scale of the printing image data.

According to another aspect of the present invention, it is possible to provide a computer readable recording medium in which an image processing program causes a computer to function as the above described image processing device is recorded.

With the above described configuration, it is possible to embed easily the digital watermarking into a blank area without making a user to perform a complicated procedure even when the blank area on a manuscript is small.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic diagrammatical view of the entire configuration of an image processing system according to a first preferred embodiment of the present invention;

FIG. 2 is a view of a diagram illustrating a mechanical configuration of a computer of the image processing system;

FIG. 3 is a view of a functional block diagram of the computer of the image processing system;

FIG. 4 is a view of a diagram illustrating data configuration of a background-marking data table used by the computer;

FIG. 5 is a view of an image illustrating a condition in which printing image data are output by the system;

FIG. 6 is a view of a flowchart illustrating a series of image processing steps performed by the computer according to the first preferred embodiment;

FIG. 7 is a view of a functional block diagram of a computer according to a second preferred embodiment of the present invention; and

FIG. 8 is a view of a diagram illustrating data configuration of a background-marking data table used by the computer of the second embodiment.

### DETAILED DESCRIPTION OF THE PREFERRED EMBODIMENTS

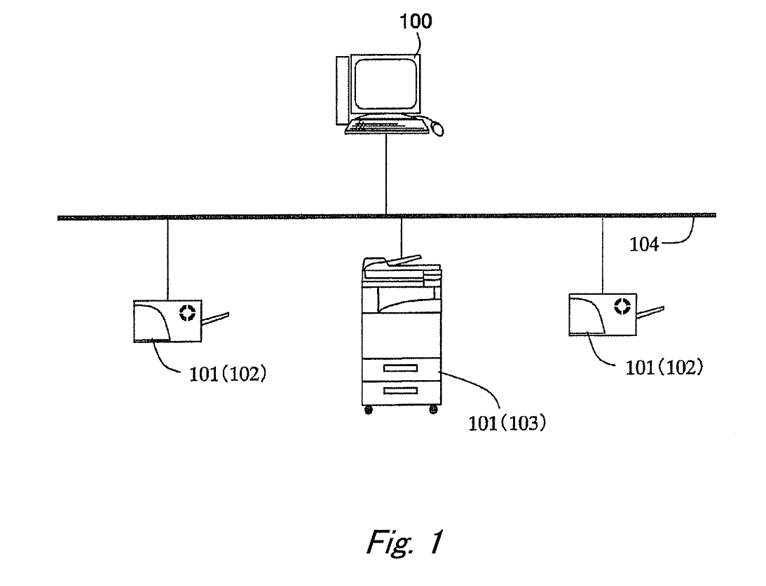

Selected embodiments of the present invention will now be explained with reference to the attached drawings to understand the present invention. FIG. 1 is a schematic diagram of the entire configuration of an image processing system according to a first preferred embodiment of the present invention.

The present invention is embodied as a computer 100 that is connected to a printing device 101 such as a printer 102 and a multifunctional peripheral (MFP) 103 through a network 104, for instance. A commonly-used general computer such as a personal computer and a server is allowed to be used as the computer 100. The computer 100 produces the digital watermarking and embeds it into the printing image data. Then, the computer 100 outputs the printing image data into which the digital watermarking is embedded to the printing device. The printing device 101 prints the printing image into which the digital watermarking is embedded onto a sheet of paper based on the obtained printing image data with the digital watermarking.

According to the present embodiment, the data to be embedded as the digital watermarking are configured to be the background-marking image data that are printed out as a dot pattern together with the printing image data. Even when the paper onto which the printing image is printed is leaked, it is possible to specify the source from which the paper is leaked by the tracking information embedded into the dot pattern (also referred to as a background-marking pattern or a background-marking tile) that is made of a plurality of dots. As a result, it is possible to prevent the illegal leakage.

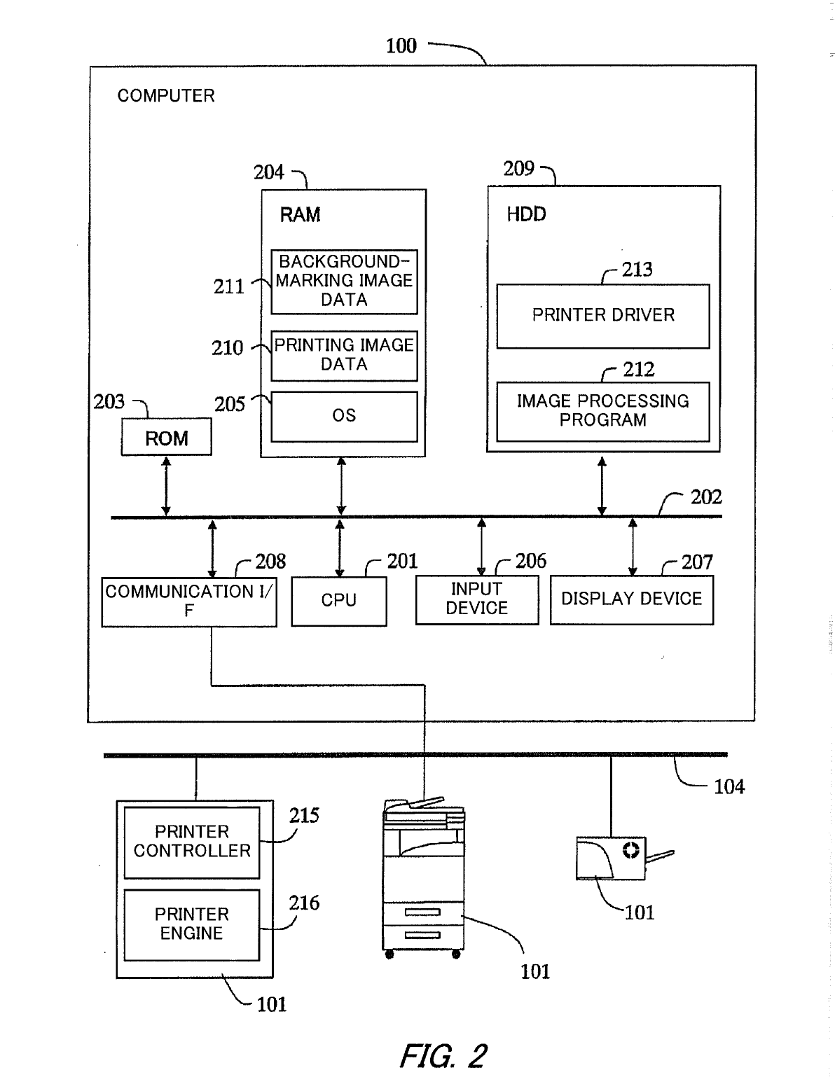

FIG. 2 is a view of a diagram illustrating an example of a hardware configuration of a computer configured to be used for image processing. The computer 100 includes a central processing unit (CPU) 201 and a bus 202. The CPU 201 is connected to a read-only memory (ROM) 203 and a random access memory (RAM) 204 through the bus 202. When the computer 100 is started up according to a program instruction stored in the ROM 203, the CPU 201 makes a portion or the entire of an operating system (OS) 205 operate on the RAM 204. In addition, a file(s) of printing image data 210 and/or background-marking data 211 is/are stored in the RAM 204 based on input by a user.

An input device 206, a display device 207, and a communication interface (communication I/F) 208 are connected to the bus 202. A cursor device such as a mouse or a trackball, and/or a keyboard are/is allowed to be used as an input device 206. A liquid-crystal display (LCD) or a cathode-ray tube (CRT) display is allowed to be used as the display device 207. The computer 100 is connected to the network 104 by the communication I/F 208.

In addition, a hard disk drive (HDD) 209, which is one of the storage devices, is connected to the bus 202. The HDD 209 stores a file(s) of an image processing program 212 that performs a processing of printing image data 210. Here, the image processing program 212 is a program that makes the computer 100 function as an image processing device. The CPU 201 reads the image processing program 212 out of the HDD 209 through the bus 202, and performs processing of the printing image data 210 according to an instruction of the program 212. The processing includes processing to embed the background-marking data 211 into the printing image data 210.

Furthermore, the HDD 209 stores a file(s) of a printer driver 213 in addition to the file(s) of the image processing program 212. The file of the printer driver 213 is preliminarily stored in the HDD 209 depending on the kind of printing device 101 used by a user of the computer 100. It is called up when a printing instruction by a user is received. The printer driver 213 converts the data into a format that the corresponding printing device 101 is capable of processing, and outputs the printing data to the printing device 101. For example, when the printer 102 receives the printing data through the network 104, a printer engine 216 prints out the data onto a sheet of paper according to the control by a printer controller 215.

As described above, the computer 100 performs input and output of the file(s) stored in the ROM 203 and the HDD 209 in response to the instruction by the image processing program 212 and the printer driver 213, and functions as an image processing device that processes the printing image data stored in the RAM 204, for instance.

Specific steps for processing the printing image data will be hereinafter explained. The following devices operate when the CPU 201 executes a program.

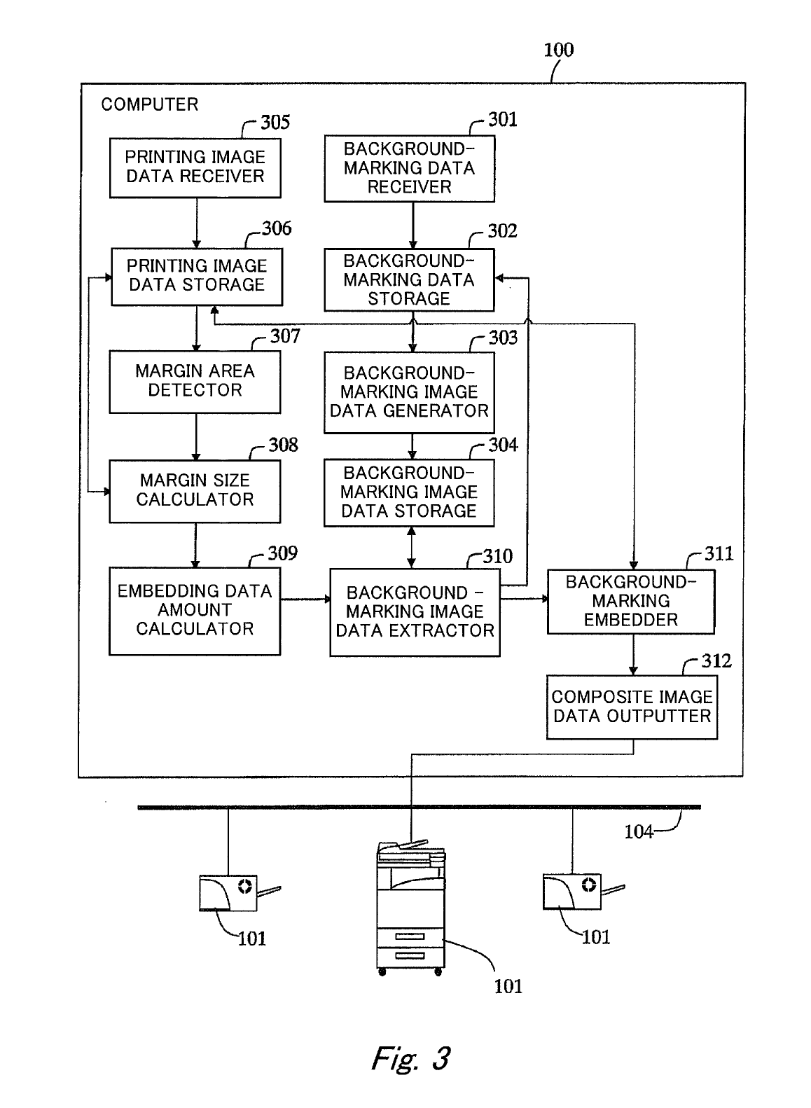

FIG. 3 is a view of a diagram illustrating an example of a functional configuration of an image processing device. The computer 100 includes a background-marking data receiver 301, a background-marking data storage 302, a background-marking image data generator 303, and a background-marking image data storage 304.

The background-marking data receiver 301 receives the background-marking data inputted through the input device by a user. The received background-marking data are stored as the background-marking data table in the background-marking data storage 302.

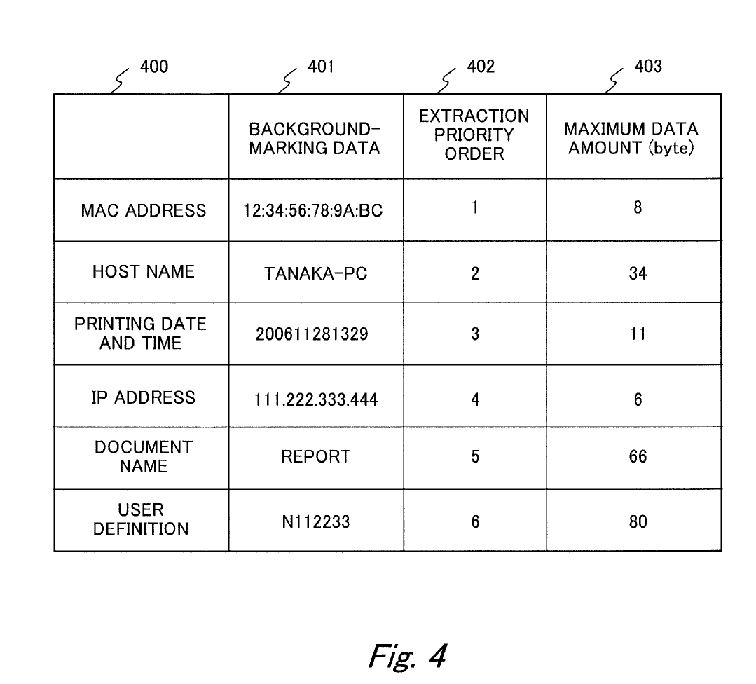

FIG. 4 is a diagram illustrating an example of the data structure of the background-marking data table. Background-marking data 401, extraction priority order 402, and maximum data amount 403 of the background-marking are contained in the background-marking data table 400.

The background-marking data 401 are information of a source from which information is outputted, which is used to specify the source of leakage. As illustrated in FIG. 4, a variety of data are allowed to be used as the background-marking data 401, such as a unique address for a computer (e.g., media access control (MAC) address and an IP address) that is necessary to receive and to send data through a network, a host name that is given to a computer on the network, a printing date and time, a document name, and a user-defined information (e.g., a code or a name of a user).

The extraction priority order 402 is set to a plurality of sets of background-marking data 401 by a user. The extraction priority order 402 according to the present embodiment is sequentially set in the order of the MAC address, the host name, the printing data and time, the IP address, the document name, and the user-defined information. In addition, the maximum data amount 403 that is allowed to be embedded in each of the plurality of sets of background-marking data 401 is secured by the user setting. In other words, a user is allowed to input the background-marking data including the data amount that is the same as or less than the preliminarily secured maximum data amount 403. For example, as illustrated in FIG. 4, the data amount up to 8 bytes is secured as the background-marking data 401 of the MAC address. Therefore, a user is allowed to input the MAC address of 8 bytes or less.

The background-marking image data generator 303 generates image data of the background-marking image (hereinafter referred to as background-marking image data) based on the background-marking data inputted by a user. The generated background-marking image data are stored in the background-marking image data storage 304.

Referring to FIG. 3, in addition, the computer 100 includes a printing image data receiver 305, a printing image data storage 306, a margin area detector (margin area detecting device) 307, a margin size calculator (margin size calculating device) 308, an embedding data amount calculator (data amount calculating device) 309, a background-marking image data extractor (extracting device) 310, a background-marking embedder (embedding device) 311, and a composite image data outputter 312.

The printing image data receiver 305 receives the printing image data that are inputted through the input device by a user, and stores the received printing image data in the printing image data storage 306.

The margin area detector 307 detects a margin area within a printable area for which printing of the image data of a manuscript is allowed to be performed. Here, the margin area is an area configured not to an object for which printing is performed. Specifically, the printing image data are firstly read out of the printing image data storage 306, and then the read out data are expanded to image data by which an image to be printed is visually recognizable. According to the present embodiment, the bitmap data are used. The bitmap data are the data that expresses an image as a group of dots aligned in a reticular pattern. Then, a margin area (i.e., non-printing (non-dotted) area) is detected by referring to the image of the bitmap data.

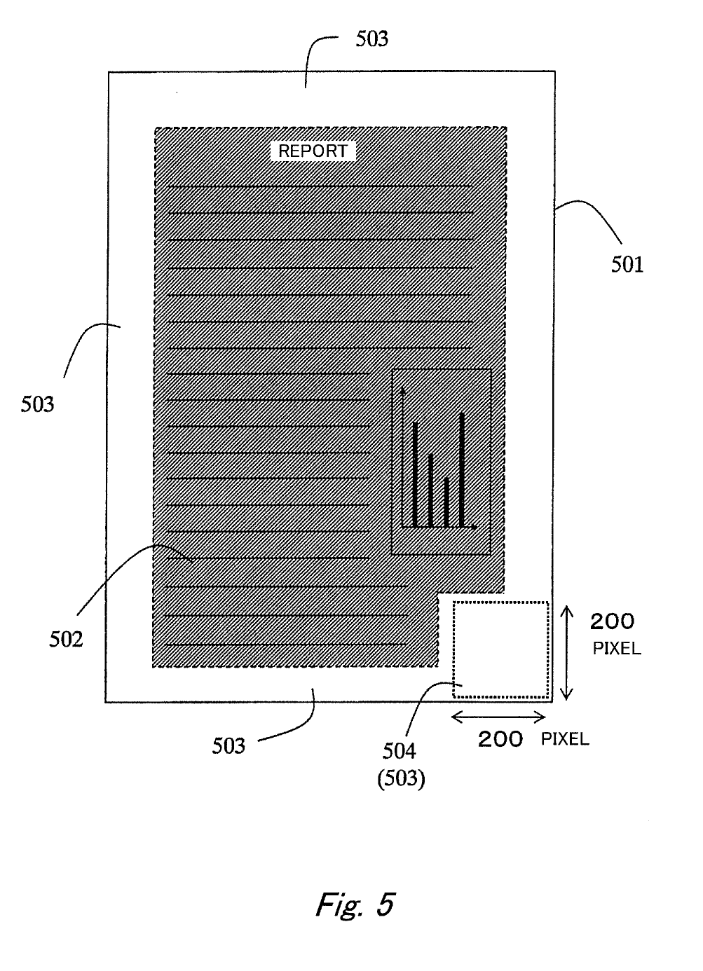

FIG. 5 is a view of a diagram illustrating an image in a condition in which the printing image data are outputted. A printable area 501 is configured to be the entire printing surface of a manuscript, and includes a printing area 502 that is configured to be an object for which printing is performed (i.e., an area on a sheet of paper onto which a printing image is supposed to be printed) and a margin area 503 that is configured not to be an object for which printing is performed (i.e., an area on a sheet of paper onto which a printing image is not supposed to be printed). According to the present embodiment, a maximum margin area 504 that is formed in a square shape with the maximum size is detected.

The margin size calculator 308 calculates the size of the maximum margin area 504 detected by the margin area detector 307. As is the case with the above, the printing image data are expanded to the bitmap data, and the size of the margin area is calculated by referring to the expanded bitmap data. As illustrated in FIG. 5, the maximum margin area 504 in accordance with the present invention is calculated by the formula of the longitudinal length and the crosswise length (e.g., 200 pixel (portrait orientation)×200 pixel (landscape orientation)).

The embedding data amount calculator 309 calculates the data amount of the background-marking image data that are allowed to be embedded into the maximum margin area 504 (i.e., the data amount of the background-marking image data corresponding to the size of the maximum margin area 504) based on the size of the maximum margin area 504 calculated by the margin size calculator 308. It is possible to calculate the value by referring to the data amount calculation table (not illustrated in the figure) stored in the HDD, for instance. Correspondence relation of the size of the margin area and the data amount that is allowed to be embedded into the margin area is contained in the data amount calculation table. Therefore, when the size of the maximum margin area 504 is obtained (e.g., 200 pixel (portrait orientation)×200 pixel (landscape orientation)), it is possible to calculate the data amount (e.g., 80 bytes) that corresponds to the maximum margin area 504.

The background-marking image data extractor 310 extracts the background-marking image data, which are actually embedded as a background-marking, from a plurality of sets of background-marking image data stored in the background-marking image data storage 304. Specifically, the background-marking image data are extracted such that the total amount of data of the background-marking image data does not exceed the embeddable data amount calculated by the embedding data amount calculator 309. For example, when the amount of the embeddable data is calculated to be 80 bytes, a single or plurality of sets of background-marking image data is extracted such that the total amount is the same as or less than 80 bytes.

In addition, the background-marking image data extractor 310 extracts the background-marking data in the descending order of the extraction priority order 402 of the background-marking data 401. In an example illustrated in FIG. 4, four background-marking image data, that is, the MAC address (8 bytes), the host name (34 bytes), the printing date and time (11 bytes), and the IP address (6 bytes), are extracted according to the extraction priority order 401. This is because the total amount of the data (59 bytes) obtained by summing the four background-marking image data (i.e., summing 8, 34, 11, and 6 bytes) do not exceed the embeddable data amount (80 bytes). On the other hand, the document name (66 bytes), which is subsequently ranked in the extraction priority order 402, is not allowed to be extracted. This is because the total amount of the data (125 bytes), which is calculated by summing 8, 34, 11, 6, and 66 bytes, exceeds the embeddable data amount (80 bytes) when the document name is extracted in addition to the above described four background-marking image data.

The background-marking embedder 311 embeds the background-marking image data extracted by the background-marking image data extractor 310 into the maximum margin area 504 detected by the margin area detector 307, and generates composite image data with a background-marking.

The composite image data outputter 312 outputs the composite image data to the printer 102, for instance. Specifically, when a user performs printing with application software, a printer driver that receives a processing request from an OS converts the composite image data into a format that a corresponding printer is capable of processing, and then the converted composite image data are outputted to the printer.

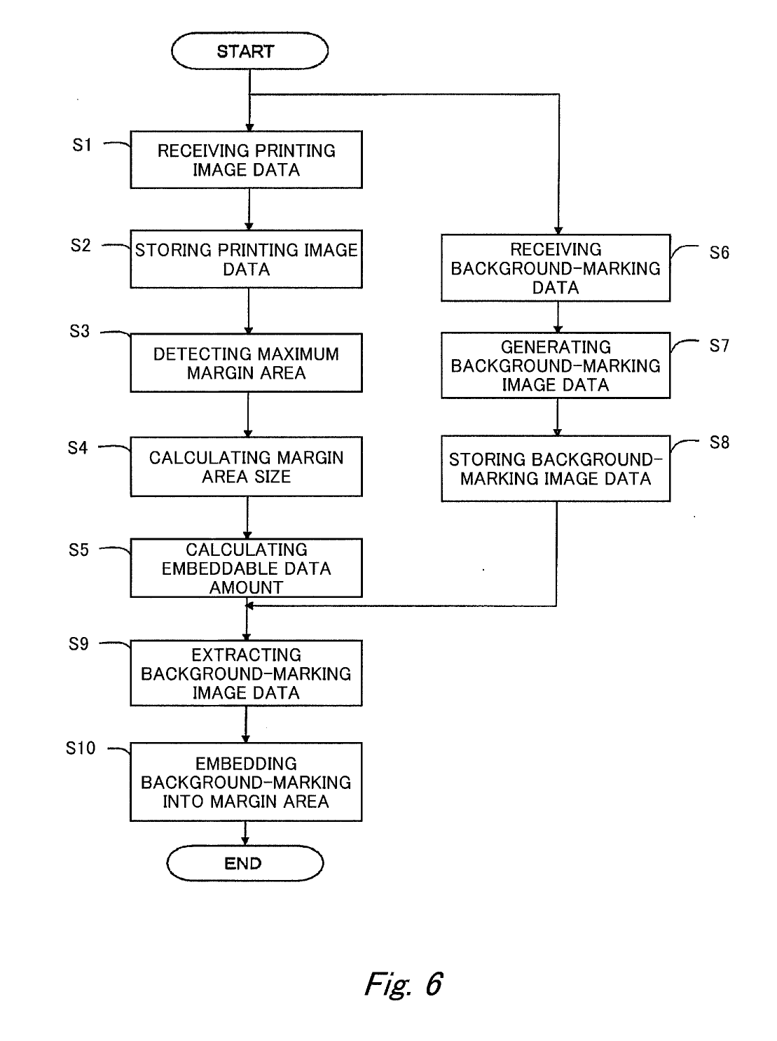

A processing flow that a computer embeds a background-marking will be hereinafter explained. FIG. 6 is a flowchart illustrating the process flow that a computer in accordance with the present embodiment embeds a background-marking.

When printing image data are inputted by a user and are received (Step S1), the printing image data are stored in the printing image data storage (Step S2). Then, the printing image data are expanded to the bitmap data, and the maximum margin area within the printable area is detected (Step S3). Next, the size of the detected maximum margin area is calculated (Step S4), and the amount of the background-marking image data that is embeddable into the maximum margin area is calculated (Step S5).

Next, a plurality of sets of background-marking data is inputted by a user and is received (Step S6). Here, not only the plurality of sets of background-marking data, but also a setting of the extraction priority order that is given to each of the plurality of sets of background-marking data and a setting of the maximum amount of the data that is allocated to each of the plurality of sets of background-marking data is received. Next, the background-marking image data are generated based on the inputted background-marking data (Step S7), and then it is stored in the background-marking image data storage (Step S8). The background-marking image data, the extraction priority order, and the maximum amount of the data are stored in the background-marking image data storage in a state that they are associated with each other.

Next, based on the amount of the background-marking image data that is embeddable into the margin area, a single or plurality of sets of background-marking image data is extracted from a plurality of sets of background-marking image data that is stored in the storage device according to the extraction priority order (Step S9). Here, the single or plurality of sets of background-marking image data is extracted such that the total amount of the background-marking image data (i.e., sum of the maximum amount of the background-marking image data to be extracted from the storage device) does not exceed the data amount that is embeddable into the margin area.

Next, the extracted background-marking image data are embedded into the margin area (Step S10).

As described above, even when a block of the margin area with a predetermined size does not exist within the printable area, it is possible to detect the maximum margin area in the existing margin areas and to embed the background-marking image data into the maximum margin area such that the background-marking image data fit in the size of the maximum margin area. Therefore, with the present embodiment, a user need not perform a conventionally performed operation that he/she secures a new margin area by reducing a printing area.

The image processing program that is used in the above described embodiment is allowed to be provided to a relevant person or a third party through a telecommunication line such as the Internet or by storing the program in a computer readable recording medium. For example, when a program instruction is expressed by means of an electric signal, an optic signal, or a magnetic signal, and the signal is transmitted while placed on a carrier wave, it is possible to provide the program through a transmission medium such as a co-axial cable, a copper line, and an optic fiber. In addition, it is possible to use an optic medium (e.g., a compact disk read only memory (CD-ROM), a compact disk recordable (CD-R), a compact disk rewritable (CD-RW), a digital versatile disk random access memory (DVD-ROM), a digital versatile disk random access memory (DVD-RAM), a digital versatile recordable (DVD-R), and a digital versatile rewritable (DVD-RW)), a magnetic media such as a flexible disk, and a semiconductor memory (e.g., a flash memory and a RAM) as a computer readable recording medium.

In addition, the above described embodiment does not limit the technical scope of the present invention, and a variety of changes and applications, other than the above described contents, are allowed to be performed within the scope of the invention.

### Second Embodiment

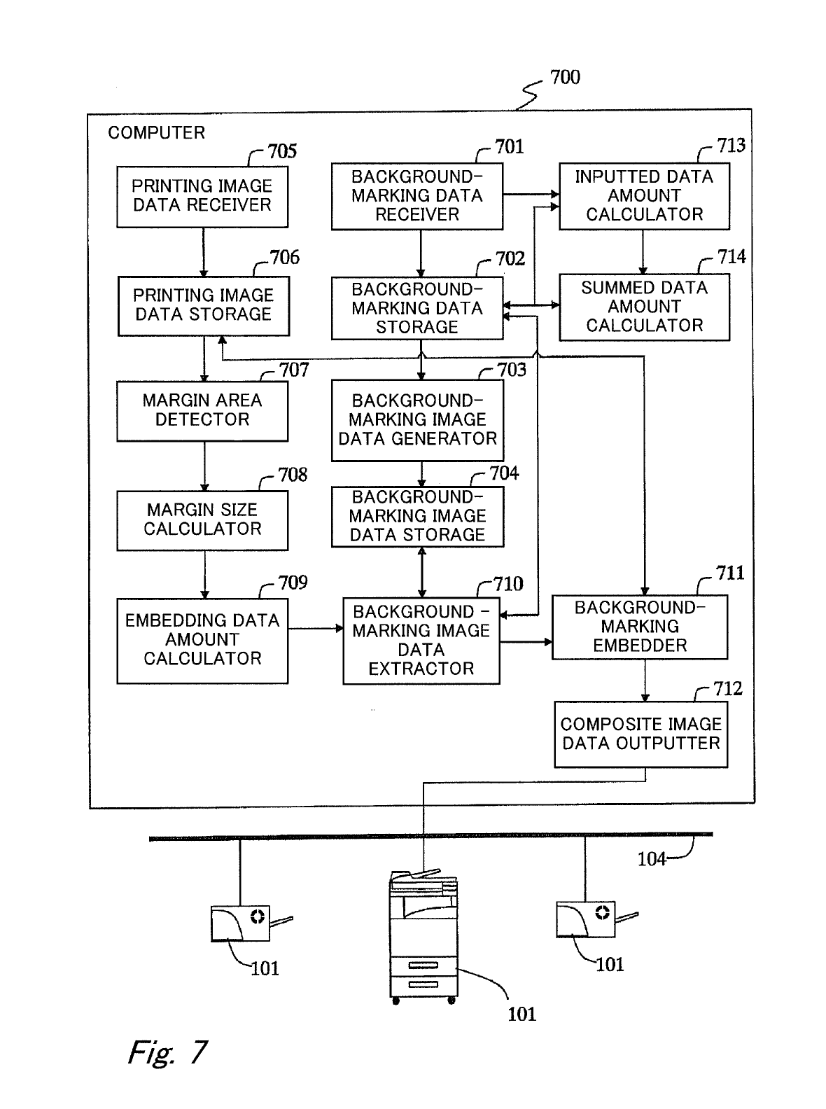

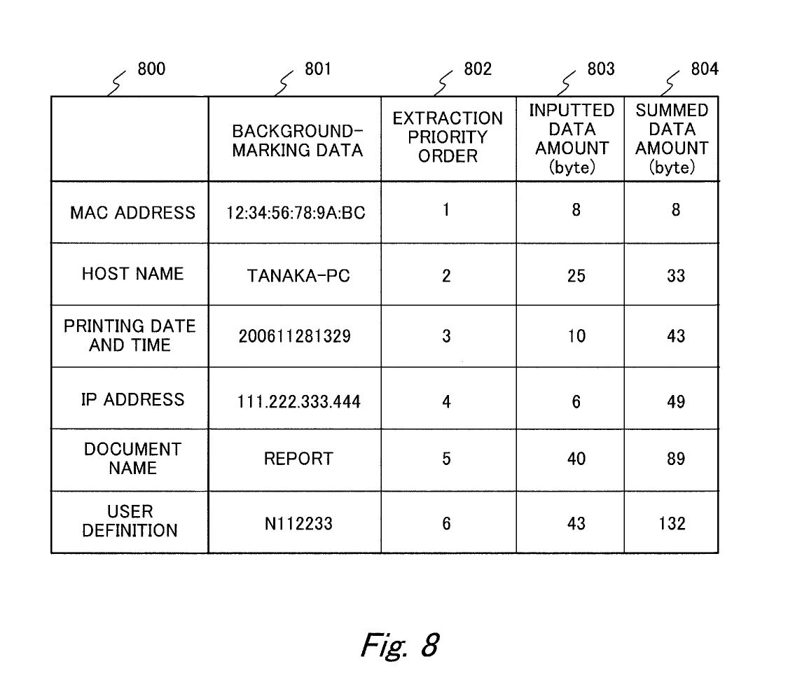

Referring now to FIGS. 7 and 8, an image processing system in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

FIG. 7 is a view of a functional block diagram of a computer according to the second preferred embodiment of the present invention. FIG. 8 is a view of a diagram illustrating the data configuration of the background-marking data table according to the second embodiment. As stated, the common contents between the alternative embodiment and the above described embodiment may hereinafter be omitted and different contents between these embodiments are hereinafter mainly explained.

As is the case with the above described embodiment, a computer 700 in accordance with the alternative embodiment includes a printing image data receiver 705, a printing image data storage 706, a margin area detector 707, a margin size calculator 708, an embedding data amount calculator 709, and functions thereof are approximately the same as those of the above described embodiment.

In addition, the computer 700 includes a background-marking data receiver 701, a background-marking data storage 702, a background-marking image data generator 703, a background-marking image data storage 704, a background-marking image data extractor 710, a background-marking embedder 711, a composite image data outputter 712, an inputted data amount calculator 713, and a summed data amount calculator 714.

When the background-marking data are inputted by a user and are received, the background-marking data receiver 701 stores the background-marking data as a background-marking data table in the background-marking data storage 702.

The inputted data amount calculator 713 calculates the amount of background-marking data 801 inputted by a user. The calculated inputted data amount 803 is contained in a background-marking data table 800 stored in the background-marking data storage 702.

The summed data amount calculator 714 sums the inputted data amount 803 calculated by the inputted data amount calculator 713. A summed data amount 804 is calculated based on an extraction priority order 802 of each of the plurality of sets of background-marking data 801. In other words, the summed data amount 804 with respect to a predetermined set of background-marking data 801 (i.e., calculation-target background-marking data 801) is calculated by summing the calculation-target background-marking data 801 and other background-marking data with a higher priority order than that of the calculation-target background-marking data 801. In an example illustrated in FIG. 8, the summed data amount of the first three extraction priority orders from the MAC address to the printing date and time corresponds to the summed data amount (43 bytes) obtained by summing the data amount of the MAC address with the first extraction priority order (8 bytes), that of the host name with the second extraction priority order (25 bytes), and that of the printing date and time with the third extraction priority order (10 bytes). Thus calculated summed data amount 804 is contained in the background-marking data table 800.

The background-marking image data generator 703 generates the background-marking image data based on the background-marking data, and stores the generated background-marking image data in the background-marking image data storage 704.

The background-marking image data extractor 710 extracts the background-marking image data according to the extraction priority order. Here, the background-marking image data extractor 710 of the present embodiment extracts the background-marking image data such that the summed data amount does not exceed the data amount calculated by the embedding data amount calculator (i.e., the embeddable data amount into the maximum margin area). In an example illustrated in FIG. 8, when the embeddable data amount is 45 bytes, the background-marking image data of the MAC address, the host name, and the printing date and time are extracted because the summed data amount of the MAC address, the host name, and the printing date and time is less than 45 bytes.

The background-marking embedder 711 embeds the extracted background-marking image data into the maximum margin area, and generates composite image data with a background-marking.

As described above, the computer of the embodiments of the present invention extracts a single or plurality of sets of background-marking data that is allowed to be embedded into a margin area of a manuscript from a plurality of background-marking data inputted by a user. The extraction is performed according to the extraction priority order. Therefore, it is possible to embed the background-marking data in the descending order of importance. Therefore, even when a manuscript does not include an enough margin area, it is not necessary to give up embedding a background-marking in the margin area or it is not necessary to perform a complicated procedure that a user producing a new margin area by reducing a printing area, as conventionally performed. It is possible to embed a single or plurality of background-marking data depending on the size of the margin area.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An image processing device for embedding digital watermarking data into image data of a manuscript; comprising:
a storage device associating and storing a plurality of sets of digital watermarking data, extraction priority order being given to each of the plurality of sets of digital watermarking data, and a maximum data amount of each of the plurality of sets of digital watermarking data allowed to be embedded into the image data of the manuscript;
a margin area detecting device detecting a margin area within a printable area, the margin area being different from an area on which image data printing is performed, the printable area being an area on which the image data of the manuscript are allowed to be printed;
a margin size calculating device calculating the size of the margin area;
a data amount calculating device calculating the data amount of the digital watermarking data allowed to be embedded within the size of the margin area;
an extracting device extracting digital watermarking data from the plurality of sets of digital watermarking data stored in the storage device according to the extraction priority order based on the data amount calculated by the data amount calculation device; and
an embedding device embedding the digital watermarking data extracted by the extracting device into the margin area.

2. A recording medium having recorded thereon an image processing program causing a computer of an image processing device to function, the image processing program, comprising:
code for causing a margin area detecting device to detect a margin area within a printable area, the margin area being different from an area on which image data printing is performed, the printable area being an area on which image data of a manuscript are allowed to be printed;
code for causing a margin size calculating device to calculate the size of the margin area;
code for causing a data amount calculating device to calculate the data amount of the digital watermarking data allowed to be embedded within the size of the margin area;
code for causing an extracting device to extract digital watermarking data from the plurality of sets of digital watermarking data stored in a storage device according to the extraction priority order based on the data amount calculated by the data amount calculating device; and
code for causing an embedding device to embed the digital watermarking extracted by the extracting device into the margin area.

3. An image processing method, comprising:
detecting a margin area within a printable area, the margin area being different from an area on which image data printing is performed, the printable area being an area on which image data of a manuscript are allowed to be printed;
calculating the margin area size;
calculating a data amount of digital watermarking data that are allowed to be embedded within the size of the margin area;
extracting digital watermarking data to be embedded from a plurality of sets of digital watermarking data to which extraction priority order are given according to the extraction priority order based on the data amount; and
embedding the extracted digital watermarking data into the margin area.
